(19) United States
(12) Patent Application Publication
(10) Pub. No.: US 2020/0307017 A1
(43) Pub. Date: Oct. 1, 2020

(54) ADDITIVE MANUFACTURING PRINTHEAD

(71) Applicant: Oshkosh Corporation, Oshkosh, WI (US)

(72) Inventors: Kai Schubart, Oshkosh, WI (US); Jeff Maveal, Oshkosh, WI (US); Justin Madsen, Oshkosh, WI (US); Brandon Mich, Oshkosh, WI (US); Nicholas Sonnentag, Oshkosh, WI (US); Robert M. Hathaway, Oshkosh, WI (US)

(73) Assignee: Oshkosh Corporation, Oshkosh, WI (US)

(21) Appl. No.: 16/811,387

(22) Filed: Mar. 6, 2020

Related U.S. Application Data
(60) Provisional application No. 62/823,152, filed on Mar. 25, 2019.

(51) Int. Cl. B28B 1/00; B28B 17/00; B28B 17/02

(52) U.S. Cl. CPC B28B 1/001; B33Y 10/00; B28B 17/02; B28B 17/0072

(57) ABSTRACT

A printhead for an additive manufacturing system includes a hopper, an outlet, a mixing shaft, and a drive shaft. The hopper includes an inner volume configured to store a slurry material for mixing. The outlet includes a passageway fluidly coupled with the hopper. The outlet includes an open end for discharging the slurry material to a surface through the passageway. The mixing shaft extends through the inner volume of the hopper and includes a member that extends radially outwards from the mixing shaft. The member is configured to mix the slurry material within the hopper as the mixing shaft rotates. The drive shaft extends through the inner volume of the hopper and at least partially into the passageway of the outlet. The drive shaft includes a sloped surface configured to drive the slurry material from the hopper to the surface through the passageway of the outlet.

### CROSS-REFERENCE TO RELATED PATENT APPLICATION

This application claims the benefit of and priority to U.S. Provisional Patent Application No. 62/823,152, filed Mar. 25, 2019, the entire disclosure of which is incorporated by reference herein.

### BACKGROUND

The present disclosure relates to additive manufacturing. More specifically, the present disclosure relates to additive manufacturing printheads for commercial applications.

### SUMMARY

One implementation of the present disclosure is a printhead for an additive manufacturing system, according to an exemplary embodiment. The printhead includes a hopper, an outlet, a mixing shaft, and a drive shaft. The hopper includes an inner volume configured to store a slurry material for mixing. The outlet includes a passageway fluidly coupled with the hopper. The outlet includes an open end for discharging the slurry material to a surface through the passageway. The mixing shaft extends through the inner volume of the hopper and includes a member that extends radially outwards from the mixing shaft. The member is configured to mix the slurry material within the hopper as the mixing shaft rotates. The drive shaft extends through the inner volume of the hopper and at least partially into the passageway of the outlet. The drive shaft includes a sloped surface configured to drive the slurry material from the hopper to the surface through the passageway of the outlet.

Another implementation of the present disclosure is a system for additive manufacturing with a slurry material, according to an exemplary embodiment. The system includes an adjustable support structure, a printhead, and a controller. The printhead is suspended from the adjustable support structure and includes a hopper, a first shaft, and a second shaft. The hopper is configured to store a slurry material. The printhead also includes an outlet fluidly coupled with the hopper and configured to discharge the slurry material. The first shaft is configured to be driven by a first motor to mix the slurry material. The second shaft is configured to be driven by a second motor to discharge the slurry material. The controller is configured to operate a primary mover of the adjustable support structure to reposition the printhead. The controller is also configured to operate the first motor and the second motor of the printhead to mix the slurry material and discharge the slurry material.

Another implementation of the present disclosure is a method for performing additive manufacturing with a slurry material, according to an exemplary embodiment. The method includes providing a printhead having a hopper for storing, processing, and mixing a slurry material. The printhead also includes an outlet portion for discharging the slurry material to a print surface. The printhead includes a first shaft configured to be driven by a first primary mover to mix the slurry material and a second shaft configured to be driven by a second primary mover to discharge the slurry material through the outlet portion. The method also includes driving the first shaft and the second shaft to independently mix and discharge the slurry material to the print surface. The method also includes monitoring an amount of counter-torque exerted on the first shaft to determine a dynamic viscosity of the slurry material. The method also includes adding a wet ingredient or a moisture absorbing agent to the slurry material based on the dynamic viscosity of the slurry material to achieve a desired value of the dynamic viscosity.

The invention is capable of other embodiments and of being carried out in various ways. Alternative exemplary embodiments relate to other features and combinations of features as may be recited herein.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of an additive manufacturing system, including a printhead, according to an exemplary embodiment.

FIG. 2 is a diagram of the additive manufacturing system of FIG. 1 showing a side sectional view of the printhead, according to an exemplary embodiment.

FIG. 3 is a perspective view of the printhead of the additive manufacturing system of FIG. 1, according to an exemplary embodiment.

FIG. 4 is a side sectional view of a printhead of the additive manufacturing system of FIG. 1, according to an exemplary embodiment.

FIG. 5 is a graph of torque measured by a torque sensor of the printhead of the additive manufacturing system of FIG. 1 over time, according to an exemplary embodiment.

FIG. 6 is a user interface display that may be displayed to an operator of the additive manufacturing system of FIG. 1, according to an exemplary embodiment.

FIG. 7 is a block diagram of a control system that can be used to control and monitor the printhead of FIGS. 2-4, according to an exemplary embodiment.

FIG. 8 is a block diagram of the control system of FIG. 7, according to an exemplary embodiment.

FIG. 9 is a flow diagram of a process for performing additive manufacturing with a slurry material, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the FIGURES, a printhead (e.g., a nozzle, a printer head, a material delivery device, etc.) for additive manufacturing with slurry materials (e.g., concrete) is shown, according to various exemplary embodiments. The printhead can include a hopper configured to store, mix, process, etc., the slurry material. The printhead includes an outlet portion or a printing portion that is fluidly coupled with the hopper and provides the slurry material to a print surface. A shaft with helical surfaces (e.g., an auger) extends through an inner volume of the outlet portion. The shaft can extend through substantially the entire longitudinal height of the printhead. The helical surfaces extend through the inner volume of the outlet portion and may extend partially into the inner volume of the hopper. The shaft and the helical surfaces may be integrally formed and can be rotated to dispense the slurry material from the inner volume of the hopper to a print surface therebelow (e.g., through an outlet aperture at the end of the outlet portion). The shaft and the helical surfaces are driven by a drive motor. The drive motor is operated by a controller. The controller operates the drive motor such that the slurry material is dispensed at a substantially constant rate.

The print surface can be a ground surface, a surface of a work site (e.g., a foundation), or a surface of previously provided slurry material. The printhead includes an optical transducer, and an active dynamic viscosity measurement system. The optical transducer can measure a distance between the transducer and a top surface of the slurry material within the hopper. The distance can be used by a controller to determine a fill level of the hopper. The controller can operate a material delivery system (e.g., a pump) to provide ingredients for the slurry material to the hopper such that the fill level remains substantially equal to a target fill level value. The active dynamic viscosity system includes a sheath or a hollow cylindrical portion that encloses at least a portion of the shaft. The sheath includes one or more protrusions that provide some amount of surface area. The sheath and the protrusions can rotate independently of the rotation of the shaft/helical surfaces. A separate motor can be configured to drive the sheath and the protrusions.

As the sheath rotates, the one or more protrusions pass through the slurry material and experience drag forces. The drag forces produce a counter-torque on the sheath in a direction opposite the direction of rotation of the sheath. The magnitude of the counter-torque is proportional to dynamic viscosity of the slurry material. A torque sensor is configured to measure the magnitude of the counter-torque and provide the value of the counter-torque to the controller.

The controller can use the value of the counter torque to determine dynamic viscosity of the slurry material and to determine whether moisture should be added to the slurry material to reduce the dynamic viscosity of the material, or if moisture reducing agent should be added to the slurry material to increase the dynamic viscosity of the material. The controller can use the dynamic viscosity and an empirical relationship to determine an amount of moisture (e.g., water) or an amount of moisture reducing agent that should be added to the slurry mixture to return or maintain the dynamic viscosity of the slurry material at a target dynamic viscosity. The controller can either notify an operator of the printhead regarding the amount/quantity of moisture or moisture reducing agent to add, or can operate a material/ingredient delivery system to automatically provide the amount/quantity of water or moisture reducing agent to the slurry mixture in the hopper.

Maintaining a target fill level of the slurry mixture in the hopper advantageously facilitates providing the slurry mixture at a constant volumetric flow rate. Advantageously, maintaining the target dynamic viscosity of the slurry mixture facilitates workability of the slurry mixture (e.g., the slurry mixture is not too thin or too thick) and improves the repeatability and reliability of structures produced. The printhead can advantageously be used to automatically (or manually by providing notifications to the operator) maintain a constant fill level in the hopper, and maintain a constant dynamic viscosity of the slurry mixture.

The printhead can be used in additive manufacturing applications to print large-scale structures as well as smaller-scale structures. For example, the printhead may be used to produce platforms, silos, etc.

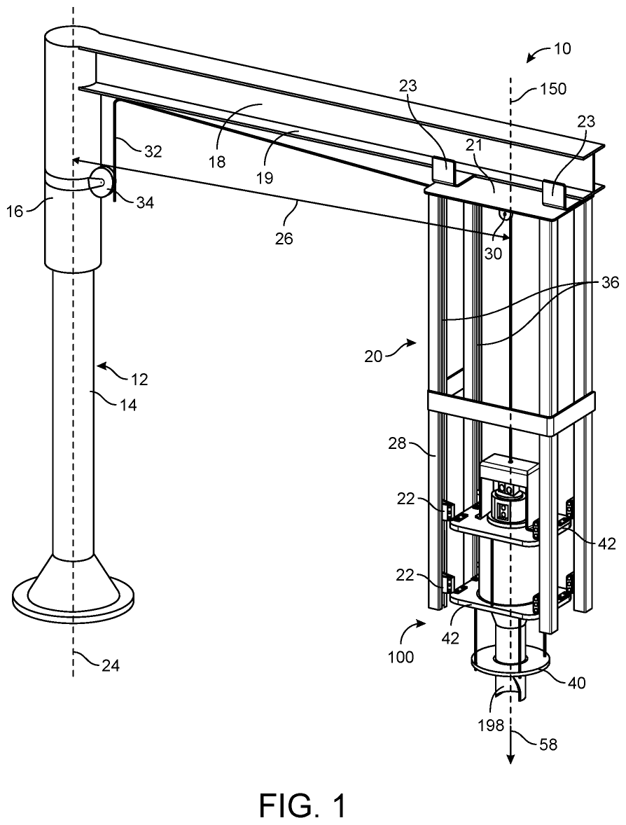

Referring now to FIG. 1, an additive manufacturing system 10 includes a member, column, bar, beam, cylinder, etc., shown as central member 12, according to an exemplary embodiment. Central member 12 can have telescoping sections configured to slidably interface with each other. Central member 12 includes a section, portion, part, etc., shown as member 14, and another section, portion, part, etc., shown as member 16. Member 14 is configured to extend into an inner volume (e.g., through an aperture) of member 16. In other embodiments, member 16 extends into an inner volume of member 14. An outer periphery, surface, face, diameter, edge, etc., of member 14 interfaces with an inner periphery, surface, face, diameter, edge, etc., of member 16. The inner surface of member 16 and the outer surface of member 14 can slidably and rotatably interface with each other, such that member 16 can translate and rotate relative to member 14. Central member 12 defines longitudinal axis 24 that extends through a center of central member 12. The overall longitudinal length of central member 12 can increase or decrease as member 16 translates along longitudinal axis 24 in an extension direction. Likewise, the overall longitudinal length of central member 12 decreases as member 16 translates along longitudinal axis 24 in a retraction/compression direction. In other embodiments, central member 12 includes more than two sections, such that central member 12 can extend and retract over a larger range.

Central member 12 can be driven to extend or retract by a piston, a hydraulic system, a motor, etc. In some embodiments, central member 12 is a hydraulic piston. In other embodiments, central member 12 includes a hydraulic piston disposed therewithin and configured to interface at one end with member 16 and at another end with member 14. In this way, central member 12 can extend and retract to increase or decrease in longitudinal length.

Member 16 and member 14 are also rotatably coupled such that member 16 can rotate relative to member 14 about longitudinal axis 24. A prime mover and/or a drive system (e.g., a motor and a shaft) can be configured to drive member 16 to rotate/pivot relative to member 14 about longitudinal axis 24 in either a clockwise direction or a counter-clockwise direction.

Member 16 includes a protrusion, an elongated member, a portion, a cantilever beam, an extended portion, a bar, a rigid member, a structural member, etc., shown as cantilever member 18. Cantilever member 18 extends radially outwards from central member 12. Cantilever member 18 can include one or more flanges, tabs, protrusions, rims, tracks, edges, etc., shown as tracks 19. Cantilever beam 18 can have a square cross-sectional shape, an I-shaped cross-section, etc., or any other cross-sectional shape (such as a regular N-sided polygon, a generally circular/elliptical shape, an irregular shape, etc.). In an exemplary embodiment, tracks 19 extend along substantially an entire length of cantilever beam 18. Tracks 19 can be flanges of cantilever beam 18 is cantilever beam 18 has a T-shaped cross-section or an I-shaped cross-section. Tracks 19 can extend along either or both sides of cantilever beam 18. Tracks 19 may be integrally formed with cantilever beam 18.

In other embodiments, cantilever beam 18 includes a channel, groove, recession, etc., that extends along substantially the entire length of cantilever beam 18. The channel, groove, recession, etc., can function as a female portion of a track and can receive/interface with a male member configured to slide along and interface with the female portion of the track.

A frame assembly 20 can be translatably coupled to cantilever beam 18. Frame assembly 20 includes one or more rigid members 28 that extend at least partially along longitudinal axis 24. In an exemplary embodiment, rigid members 28 extend in a direction that is substantially parallel to longitudinal axis 24.

Frame assembly 20 includes an upper plate, structural support member, frame, etc., shown as support 21. Support 21 includes one or more tabs, protrusions, hooks, L-shaped members, U-shaped members, etc., shown as track members 23. Track members 23 are configured to interface with track 19 to translatably and slidably couple frame assembly 20 with cantilever beam 18. Frame assembly 20 can translate along cantilever beam 18 to achieve various positions (e.g., various radial distances from longitudinal axis 24 of central member 14). Frame assembly 20 can be driven to translate along cantilever beam 18 in either direction via rollers, a motor, a pulley system, an actuator, a piston, a hydraulic piston, etc.

Frame assembly 20 includes a nozzle, hopper and nozzle system, material delivery apparatus, printing apparatus, printhead, spout, dispensing apparatus, etc., shown as printhead 100. Printhead 100 is configured to dispense, print, pour, provide, emit, etc., a material for an additive manufacturing/3-d printing application. Printhead 100 is slidably and translatably coupled with frame assembly 20 such that printhead 100 can move along frame assembly 20 in a direction substantially parallel to longitudinal axis 24. Printhead 100 can translate along substantially an entire height of frame assembly 20 to raise and/or lower printhead 100 for additive manufacturing applications.

Printhead 100 can be supported by a pulley system including pulley/roller 30, a wire, cable, string, elongated member, tensile member, etc., shown as tensile member 32, and a spool/pulley/roller 34. Spool/pulley/roller 34 can be driven by a prime mover such as a motor to raise and lower printhead 100. Printhead 100 is suspended by tensile member 32 with gravity acting in direction 58. Direction 58 may be parallel with longitudinal axis 24.

Printhead 100 is slidably and translatably interfaced with frame assembly 20 via a track system. Printhead 100 is coupled with frame assembly 20 via one or more structural support members, support plates, generally planar members, beams, etc., shown as plates 42. Plates 42 can be fixedly or rotatably interfaced with printhead 100. Plates 42 are coupled with one or more blocks, protrusions, rollers, etc., that slidably and translatably interface with a corresponding channel, gulley, recess, track, carrier, groove, trench, cut, flute, notch, etc., of rigid members 28, shown as track 36.

In other embodiments, printhead 100 is coupled to the end of a piston that is configured to translate and slide printhead 100 along frame assembly 20. In other embodiments, frame assembly 20 is not included and printhead 100 is coupled to the end of the piston. The piston can extend and retract to raise and lower printhead 100. In other embodiments, central member 12 is extended and retracted to raise and lower printhead 100. In some embodiments, pulley 34 is driven to raise and lower printhead 100 by increasing or decreasing the length of tensile member 32.

Printhead 100 defines a central axis 150, according to an exemplary embodiment. Central axis 150 may be substantially parallel to longitudinal axis 24, or may be non-parallel with longitudinal axis 24 in one or more planes. Printhead 100 is a radial distance 26 from longitudinal axis 24 of central member 12. Radial distance 26 is measured between longitudinal axis 24 and central axis 150. Radial distance 26 can be increased or decreased by driving frame assembly 20 to translate along cantilever beam 18.

Additive manufacturing system 10 can be used to print/produce generally circular, or generally arcuate components, parts, pieces, walls, towers, etc. Additive manufacturing system 10 can dispense/print material via printhead 100. Printhead 100 can be swept along an arcuate or circular path by driving member 16 to rotate relative to member 14 while dispensing/printing material. In this way, a layer of material can be printed/produced. Central member 12 can extend and the sweep can be re-performed such that another layer of material is provided on top of the previously printed layer of material. This can be repeated until a structure with a desired height is produced.

In an exemplary embodiment, additive manufacturing system 10 prints a slurry material such as concrete via printhead 100. Printhead 100 is configured to dispense the slurry material such that the slurry material can be used in additive manufacturing. Printhead 100 can maintain a viscosity (e.g., dynamic or kinetic), slump, density, rheological property, etc., of the material so that the material can be used in additive manufacturing. Printhead 100, and the various components, portions, configurations, etc., are described in greater detail below. Additionally, a control system can be used to maintain consistent properties of the material. Printhead 100 may be configured to process (e.g., mix, add moisture, etc.) the material such that required rheological properties are maintained throughout operation of additive manufacturing system 10.

It should be understood that while only one example of an additive manufacturing system is shown, printhead 100 can be used with a variety of additive manufacturing systems. Printhead 100 is configured for use with slurry materials such as concrete. However, any additive manufacturing system that can translate and/or re-orient printhead 100 may be used.

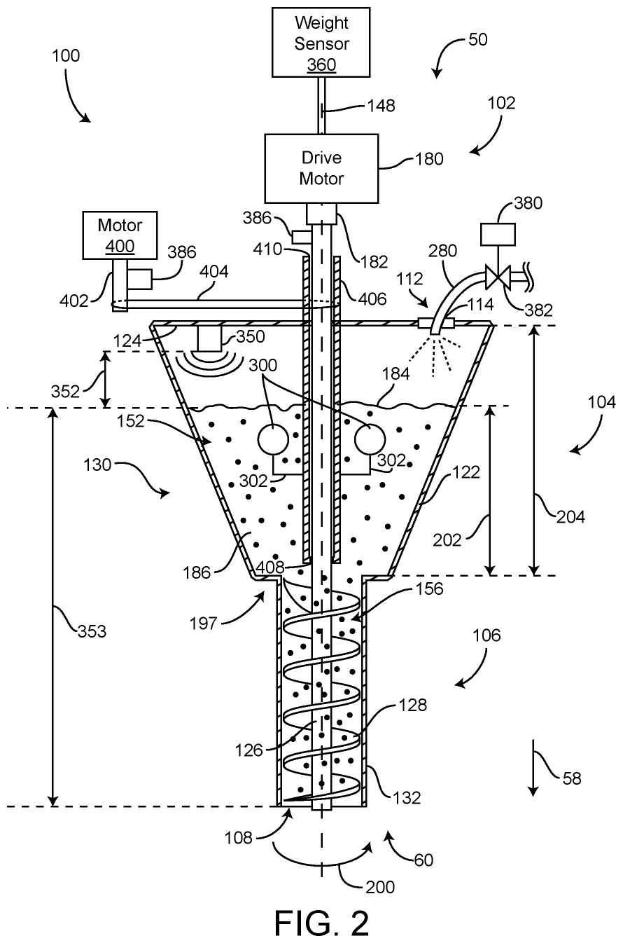

Referring now to FIGS. 2-4, printhead 100 includes an upper portion, a storage portion, a tank, a hopper, a reservoir, a mixing portion, a container, a processing portion, a sensing portion, etc., shown as hopper 104. Printhead 100 includes a lower member, a dispensing portion, a pouring portion, a printing portion, an emitting portion, an ejecting portion, a lower portion, a directing portion, an elongated portion, etc., shown as outlet portion 106. Hopper104 is configured to receive, store, mix, (or otherwise process) and provide the material to outlet portion 106. Outlet portion 106 is configured to dispense, print, pour, emit, lay, distribute, eject, pass, extrude, etc., material therebelow. Outlet portion 106 may receive the material from hopper 104 and provide the material to a surface (e.g., a ground surface, a flat surface, an upper surface of a layer of previously provided material, etc.) for producing a structure. Printhead 100 has an upper end 50 and a lower end 60.

Hopper 104 includes a converging portion, a storage portion, a mixing portion, a processing portion, etc., shown as frustoconical portion 130. Hopper 104 includes another storage portion, mixing portion, processing portion, etc., shown as storage portion 120. Storage portion 120 and frustoconical portion 130 can be integrally formed, removably coupled, fixedly coupled, fastened, etc. Storage portion 120 and frustoconical portion 130 are configured to store, process, mix, etc., material therewithin. Storage portion 120 includes a wall, surface, sidewall, shell, thin rigid member, sheet, etc., shown as sidewall 154. Frustoconical portion 130 similarly includes a wall, surface, sidewall, shell, thin rigid member, sheet, etc., shown as sidewall 122. Sidewall 154 and sidewall 122 of printhead 100 independently and/or collectively define a volume, space, area, chamber, etc., shown as inner volume 152 for storing, processing, mixing, etc., material therewithin. Storage portion 120 and frustoconical portion 130 are fluidly coupled with outlet portion 106 such that material that is stored, processed, mixed, etc., in inner volume 152 can be provided to a volume, chamber, space, etc., shown as inner volume 156 of outlet portion 106.

Hopper 104 and outlet portion 106 are both centered about central axis 150 of printhead 100. Central axis 150 extends through the center of printhead 100 and defines a longitudinal direction with directions along (e.g., parallel to) central axis 150 towards upper end 50 being “upwards” directions and directions along (e.g., parallel to) central axis 150 towards lower end 60 being “downwards” directions.

Inner volume 156 of outlet portion 106 is defined by a surface, periphery, wall, sidewall, shell, etc., of outlet portion 106 shown as sidewall 132. In some embodiments, sidewall 132 of outlet portion 106, sidewall 122 of frustoconical portion 130, and sidewall 154 of storage portion 120 are integrally formed. In other embodiments, sidewall 132, sidewall 122, and sidewall 154 are removably coupled, fastened, etc., such that any connections between sidewall 132, sidewall 122, and sidewall 154 are fluidly sealed (e.g., do not allow the flow of material therethrough).

Sidewall 132 of outlet portion 106 has a circular cross-sectional shape. In some embodiments, sidewall 132 of outlet portion 106 has a circular cross-sectional shape along substantially an entire length of outlet portion 106. In other embodiments, sidewall 132 of outlet portion 106 has a cross-sectional shape that varies along the length of outlet portion 106. In some embodiments, sidewall 132 of outlet portion 106 has a circular cross-sectional shape that has a decreasing (e.g., linearly, or non-linearly decreasing) radius/diameter/area at a bottom end of outlet portion 106 thereby defining a nozzle or a converging portion. In other embodiments, a nozzle portion 195 that directs the material exiting outlet portion 106 is coupled (e.g., integrally formed) at the bottom end of outlet portion 106. Nozzle portion 195 can include a nozzle 198 that directs the material/mixture provided from inner volume 152 of hopper 104.

Outlet portion 106 includes an outlet, an aperture, a hole, etc., shown as outlet aperture 108. Outlet aperture 108 is configured to facilitate the egress of material/concrete from printhead 100. Outlet aperture 108 is fluidly coupled with inner volume 156 such that material/concrete can be driven out of printhead 100 through outlet aperture 108.

Sidewall 122 of frustoconical portion 130 has an inner circular-cross sectional area (e.g., an area defined within sidewall 122) with a radius that decreases (e.g., linearly) along central axis 150 from a maximum value at a top end (e.g., a top periphery) of frustoconical portion 130 to a minimum value at a bottom end of frustoconical portion 130. In some embodiments, the minimum value (or diameter) of the inner radius of sidewall 122 is greater than a radius of sidewall 132 at a transition between frustoconical portion 130 and outlet portion 106 such that a step or shoulder 197 is formed there. In some embodiments, the minimum value of the inner radius of sidewall 122 is substantially equal to the radius of sidewall 132 at the transition between frustoconical portion 130 and outlet portion 106 such that the transition between sidewall 122 and sidewall 132 is smooth.

Sidewall 154 of storage portion 120 has a constant inner radius/inner diameter along an entire longitudinal length of storage portion 120. In some embodiments, the inner radius/inner diameter of sidewall 154 is substantially equal to the maximum value of the inner radius/diameter of sidewall 122 (of frustoconical portion 130).

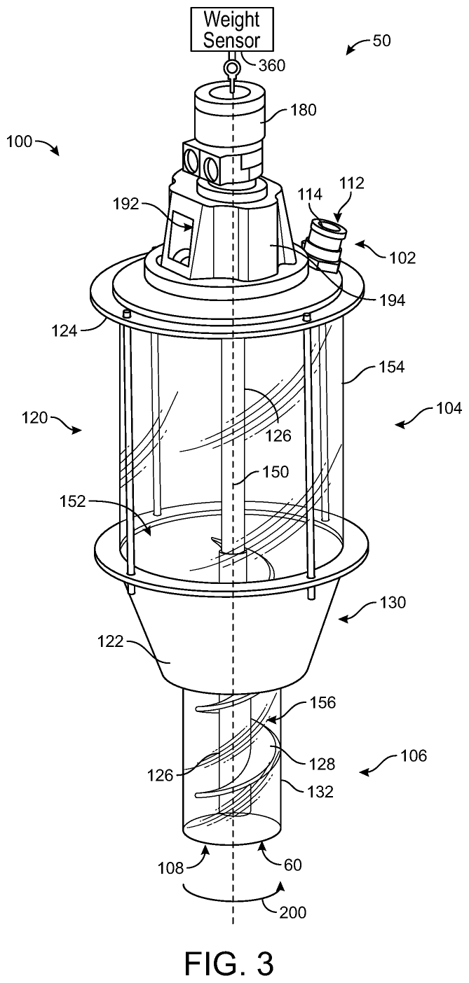

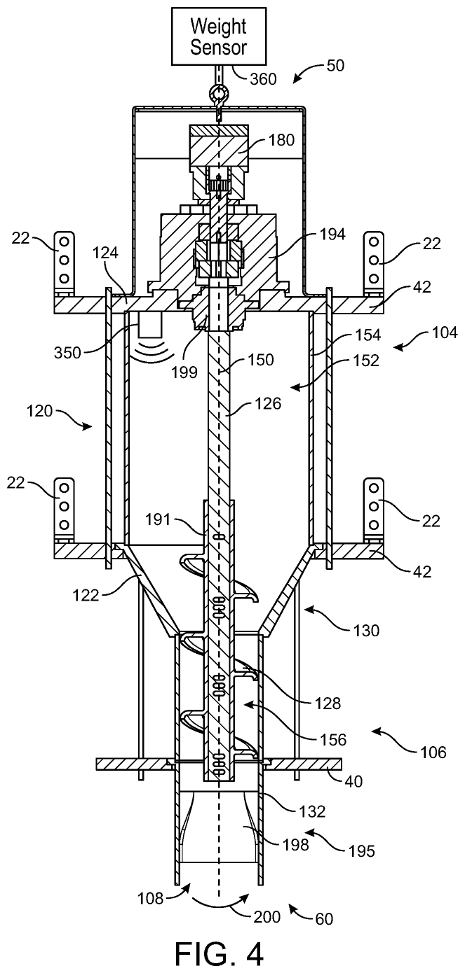

Printhead 100 includes a shaft, rotating member, cylinder, beam, bar, elongated member, etc., shown as shaft 126 that extends through inner volume 152 of frustoconical portion 130 and storage portion 120. Shaft 126 extends at least partially into inner volume 156 of outlet portion 106. In some embodiments, shaft 126 extends completely through inner volume 156 of outlet portion 106 (e.g., as shown in FIG. 2). In other embodiments, shaft 126 extends only partially through inner volume 156 of outlet portion 106 (e.g., as shown in FIGS. 3-4). Shaft 126 can be rotatably coupled with a bearing 199. Bearing 199 can be any of a roller bearing, a ball bearing, a sleeve bearing, an angular contact ball bearing, etc., or any other bearing. Bearing 199 may be coupled with an upper member, an upper surface, an upper plate, an upper receiving member, etc., shown as upper member 124. Upper member 124 can extend over substantially an entire upper portion of hopper 104. In some embodiments, upper member 124 is a cover of hopper 104. Upper member 124 can be both a cover as well as a structural support member for hopper 104. Upper member 124 can provide structural support for shaft 126. Additionally, upper member 124 can provide structural support for drive motor 180 (discussed in greater detail below). Bearing 199 can be press fit, slip fit, etc., into an aperture of upper member 124. Upper member 124 may be integrally formed or removably coupled with one of plates 42.

Shaft 126 extends along central axis 150. More specifically, shaft 126 is centered about central axis 150. Shaft 126 includes threads, inclined elements, helically inclined surfaces, etc., shown as helical surfaces 128. Helical surfaces 128 surround shaft 126 at a bottom end of shaft 126. Helical surfaces 128 can surround and wrap around shaft 126 in either a clockwise direction or a counter clockwise direction. Helical surfaces 128 and shaft 126 function as an auger that drives material/concrete from inner volume 156 and inner volume 152 out of printhead 100 via outlet aperture 108 (e.g., an Archimedean screw that operates to push/drive a fluid as opposed to elevate the fluid). Shaft 126 can be rotatably coupled with helical surfaces 128 such that rotation of shaft 126 thereby rotates helical surfaces 128 (e.g., helical surfaces 128 and shaft 126 rotate together). Shaft 126 rotates in direction 200 and forces (e.g., drives, urges, facilitates, moves, pushes, provides a force to) material through inner volume 156 of outlet portion 106. The material/concrete then exits printhead 100 via outlet aperture 108. Helical surfaces 128 may be sealingly interfaced with an inner surface of sidewall 132. In some embodiments, helical surfaces 128 have an outer diameter that is substantially equal to (or slightly less than) an inner diameter of sidewall 132. In other embodiments, a gap is formed between the outer periphery of helical surfaces 128 and the inner surface of sidewall 132 (e.g., the outer diameter of helical surfaces 128 is less than the inner diameter of sidewall 132).

Helical surfaces 128 can extend partially along the length of outlet portion 106 (as shown in FIGS. 2-4) or can extend along substantially the entire length of outlet portion 106. Helical surfaces 128 can extend at least partially into inner volume 152 of frustoconical portion 130 and/or storage portion 120.

Shaft 126 can include a shank, or a connecting portion at an upper end. Shaft 126 is rotatably coupled with a prime mover (e.g., an engine, a motor, etc.), shown as drive motor 180 at an upper end. Shaft 126 may be rotatably coupled with drive motor 180 via a driveshaft 182 of drive motor 180. In some embodiments, shaft 126 is directly rotatably coupled with drive motor 180 (e.g., directly rotatably coupled with driveshaft 182). In other embodiments, shaft 126 is rotatably coupled to a powertrain (e.g., one or more belts, pulleys, rollers, gears, etc.) that transfers mechanical energy (e.g., angular kinetic energy) from drive motor 180 to shaft 126. Drive motor 180 is configured to drive (i.e., rotate) shaft 126 to expel (e.g., push, facilitate the egress of, etc.) material from printhead 100 through outlet aperture 108. As drive motor 180 rotates, helical surfaces 128 of shaft 126 push material through outlet portion 106.

Drive motor 180 can be controlled/operated by a controller (e.g., controller 700 as shown in FIG. 7) at various angular speeds. Drive motor 180 may receive control signals from the controller and operate according to the control signals. The control signals can indicate a speed at which drive motor 180 should rotate. Drive motor 180 is a variable-speed motor, that can rotate shaft 126 at various speeds. A value of the speed of shaft 126 facilitates different volumetric flow rates of material exiting outlet aperture 108. For example, if shaft 126 spins faster, the volumetric flow rate \dot{V}ₘₐₜₑᵣᵢₐₗ increases, while if shaft 126 spins slower, the volumetric flow rate \dot{V}ₘₐₜₑᵣᵢₐₗ decreases. The volumetric flow rate \dot{V}ₘₐₜₑᵣᵢₐₗ of the material exiting printhead 100 can be controlled by operating drive motor 180 at different speeds (e.g., by providing different voltages to drive motor 180).

The volumetric flow rate \dot{V}ₘₐₜₑᵣᵢₐₗ of the material is also related to the angle θ_{helical} of helical surfaces 128. For example, if helical surfaces 128 are angled steeply, the volumetric flow rate \dot{V}ₘₐₜₑᵣᵢₐₗ of the material exiting printhead 100 increases (e.g., larger values of θ_{helical} correspond to larger values of \dot{V}ₘₐₜₑᵣᵢₐₗ). In some embodiments, the volumetric flow rate \dot{V}ₘₐₜₑᵣᵢₐₗ of material exiting printhead 100 is a function of both the angular velocity ωₘₒₜₒᵣ of drive motor 180 and the angle θ_{helical} of helical surfaces 128 (i.e., \dot{V}ₘₐₜₑᵣᵢₐₗ=f(ωₘₒₜₒᵣ, θ_{helical})).

The volumetric flow rate \dot{V}ₘₐₜₑᵣᵢₐₗ of the material exiting printhead 100 can also be related to one or more rheological properties of the material. For example, the volumetric flow rate \dot{V}ₘₐₜₑᵣᵢₐₗ may be a function of viscosity μₘₐₜₑᵣᵢₐₗ (dynamic or kinetic) of the material (i.e., \dot{V}ₘₐₜₑᵣᵢₐₗ=f(ωₘₒₜₒᵣ, θ_{helical}, μₘₐₜₑᵣᵢₐₗ). The viscosity μₘₐₜₑᵣᵢₐₗ can be related to moisture of the material, various additives of the material, type of material, etc.

The volumetric flow rate \dot{V}ₘₐₜₑᵣᵢₐₗ of the material exiting printhead 100 (e.g., via outlet aperture 108) can also be related to a total weight wₘₐₜₑᵣᵢₐₗ of the material above outlet aperture 108 (e.g., a total weight of material within printhead 100). The total weight wₘₐₜₑᵣᵢₐₗ of the material is related to the density (e.g., average density ρ_{material,avg}) ρₘₐₜₑᵣᵢₐₗ of the material, as well as a volume of material Vₘₐₜₑᵣᵢₐₗ within printhead 100. In some embodiments, the density ρₘₐₜₑᵣᵢₐₗ of the material within printhead 100 is related to the moisture content, of the material or the viscosity μₘₐₜₑᵣᵢₐₗ of the material (i.e., ρₘₐₜₑᵣᵢₐₗ=f(μₘₐₜₑᵣᵢₐₗ)). The total weight wₘₐₜₑᵣᵢₐₗ of material above outlet aperture 108/within printhead 100 can be determined several ways. The total weight wₘₐₜₑᵣᵢₐₗ can be determined by measuring a total weight of printhead 100 with weight sensor 360. Printhead 100 is suspended from weight sensor 360 via member 148. Member 148 can be a tensile member (e.g., a cable) or a rigid member. Weight sensor 260 can be coupled to frame assembly 20. Weight sensor 360 can be any force sensor such as a tension link, a load pin, a shear beam, a strain gauge, a pressure transducer, etc., or any other sensor configured to measure force (e.g., weight). Weight sensor 360 may measure a total weight, wₜₒₜₐₗ, of both printhead 100 and the material within printhead 100. The weight of printhead 100, w_{head}, can be a known value. Therefore, the weight of the material within printhead 100 can be determined as wₘₐₜₑᵣᵢₐₗ=wₜₒₜₐₗ−w_{head}.

Another approach to determining the weight and/or the fill level of material within printhead 100 is using an optical transducer 350 (e.g., a distance sensor). Optical transducer 350 can be any sensor that emits a light (or a sound wave, or an ultrasonic wave, etc.), receives the light after it reflects off surface 184 of mixture 186, and determines a distance d (shown as distance 352) between optical transducer 350 and surface 184. In some embodiments, multiple optical transducers 350 are provided about printhead 100 such that d (distance 352) at various locations can be determined. The various distances can then be averaged (e.g., to determine d_{avg}) to account for unevenness of surface 184. Since the geometry and dimensions (e.g., diameters, volumes, etc.) of printhead 100 are known, distance 352 (d or d_{avg}) can be used to determine the volume Vₘₐₜₑᵣᵢₐₗ of the material within printhead 100. In some embodiments, d or d_{avg} can be correlated with a fill level of the material within printhead 100. For example, d_{avg} or d may range from a first value dₘᵢₙ corresponding to a max fill (e.g., 100% full) to a second value dₘₐₓ corresponding to a minimum fill (e.g., 0% full). The fill percentage, Fill % can be determined as a linear relationship between d or d_{avg} and Fill %.

The volumetric flow rate \dot{V}ₘₐₜₑᵣᵢₐₗ of the material can be controlled by operating drive motor 180 at various angular speeds ωₘₒₜₒᵣ. Additionally, the volumetric flow rate \dot{V}ₘₐₜₑᵣᵢₐₗ of the material can be controlled by adjusting the angle θ_{helical} of helical surfaces 128. This can be achieved by replacing helical surfaces 128 with other helical surfaces 128 having different angles (e.g., steeper angles). Helical surfaces 128 may be removably coupled with shaft 126 such that helical surfaces 128 can be replaced. For example, as shown in FIG. 4, helical surfaces 128 may be coupled with (or integrally formed with) a sheath 191. Sheath 191 can be configured to slide over shaft 126. Sheath 191 may be threadingly interfaced with shaft 126. In other embodiments, sheath 191 is press-fit on shaft 126. In still other embodiments, sheath 191 is fastened to shaft 126 (e.g., via rivets, screws, bolts, etc.). Advantageously, sheath 191 and helical surfaces 128 can be easily removed and replaced with helical surfaces 128 having a different count (e.g., a different number of revolutions around shaft 126) and/or different angles θ_{helical}. Certain materials may be thicker (e.g., be more viscous than other) and require steeper helical surfaces 128, while other materials may require helical surfaces 128 with a lower value of θ_{helical}. Additionally, different helical surfaces 128 can be used to facilitate higher or lower (e.g., faster or slower) volumetric flow rates \dot{V}ₘₐₜₑᵣᵢₐₗ of the material.

The rheological properties of the material, as well as the volumetric flow rate of the material out of outlet aperture 108 are important for the application of additive manufacturing. Additionally, when slurry materials are used (e.g., concrete), the rheological properties, consistency, density, viscosity, volumetric flow rate \dot{V}ₘₐₜₑᵣᵢₐₗ, etc., are important so that the slurry material can be provided to a surface (e.g., a ground surface, a printing surface, a surface of previously laid slurry material, etc.) and retain its shape/form while curing. However, the slurry material also cannot be too viscous since this may cause wear and tear or clogging of various components of printhead 100. Furthermore, moisture (which is related to viscosity) of the slurry material can be related to strength of the material (e.g., compressive strength) after the material has hardened. Furthermore, for additive manufacturing, it is desirable to keep the volumetric flow rate \dot{V}ₘₐₜₑᵣᵢₐₗ substantially constant throughout the printing process. However, the viscosity of the material can affect the volumetric flow rate \dot{V}ₘₐₜₑᵣᵢₐₗ. For example, if the material is less viscous, the material may “slide” out of the delivery outlet portion 160, thereby increasing \dot{V}ₘₐₜₑᵣᵢₐₗ. On the other hand, if the material is too viscous, the material may not lay properly or may cause degradation and/or clogging of components of printhead 100. Therefore, in order to use slurry materials for additive manufacturing, it is advantageous to keep the volumetric flow rate \dot{V}ₘₐₜₑᵣᵢₐₗ of the material relatively constant, and to control the various properties (e.g., viscosity, moisture content, etc.) of the material relatively constant. Printhead 100 is configured to mix the slurry material, delivery the slurry material at a constant volumetric flow rate \dot{V}ₘₐₜₑᵣᵢₐₗ, and maintain various properties of the slurry material that improve strength and deliverability.

Printhead 100 includes an inlet 112. Inlet 112 is configured to fluidly couple with a delivery hose, pipe, conduit, tube, tubular member, delivery system, etc., shown as hose 280. Inlet 112 includes an aperture, hole, bore, etc., shown as aperture 114. Aperture 114 is configured to fluidly couple inlet 112 with inner volume 152 of printhead 100. Aperture 114 is configured to facilitate the provision of water, or any other fluid to the material within inner volume 152 of printhead 100. Hose 280 is configured to receive fluid (e.g., water) from a fluid delivery system of a fluid source 388 (e.g., a tank, a reservoir, a capsule, a container, etc.) and provide the water/fluid into inner volume 152 of printhead 100 via aperture 114 and inlet 112. Hose 280 can sealingly and fluidly couple with inlet 112. For example, hose 280 may be configured to slide over inlet 112 and sealingly interface with an outer periphery of inlet 112. In other embodiments, hose 280 is a rigid conduit. The rigid conduit may be threadingly and sealingly interfaced with threads disposed about an inner periphery of aperture 114 (or threadingly and sealingly interfaced with threads disposed about an outer periphery of inlet 112). The interface between hose 280 (or a rigid conduit) and inlet 112 can include one or more seals (e.g., O-rings) to prevent the leakage of the fluid therebetween.

Hose 280 can include a valve 383 disposed along a fluid flow path defined by hose 280 between inner volume 152 and the fluid delivery system. Valve 283 can actuate between a closed position and an open position to either restrict the flow of fluid/water into inner volume 152 or to facilitate the flow of fluid/water into inner volume 152, or to a position that is partially open/partially closed. Valve 283 can be controlled by an actuator, shown as water delivery actuator 380. Valve 283 can be a pressure compensated flow valve, a variable flow valve, a regulator, etc. Valve 283 can be a component of the fluid delivery system. Valve 283 can be actuated to control a volumetric flow rate of water provided to inner volume 152.

Referring particularly to FIG. 2, printhead 100 is configured to mix/churn the material within inner volume 152. Printhead 100 is also configured to measure a torque associated with a member passing through the material. The torque can be used to determine a viscosity of the material. Printhead 100 includes a sleeve, case, enclosure, hollow member, etc., shown as sleeve 406. Sleeve 406 is configured to extend along shaft 126. Sleeve 406 can have the shape of a cylindrical member with an inner volume therewithin that shaft 126 extends within. Sleeve 406 may have an aperture, hole, opening, etc., shown as aperture 410 at an upper end of sleeve 406. Shaft 126 extends through aperture 410 at the upper end of sleeve 406. Sleeve 406 includes an aperture, hole, opening, etc., at a bottom/lower end, shown as aperture 408. Sleeve 406 extends through aperture 408 at the bottom/lower end. Sleeve 406 can have a stepped end, or any number of stepped portions (e.g., changes in diameter/radius along the length of sleeve 406). In an exemplary embodiment, aperture 408 has a diameter substantially equal to or greater than the outer diameter of shaft 226 such that shaft 226 can pass through aperture 408. Aperture 408 can have a diameter that is less than the diameter of aperture 410.

Aperture 408 may slidably interface with and/or provide structural support to shaft 226. In some embodiments, a bearing is disposed between aperture 408 and the outer periphery/diameter of shaft 226 to rotatably interface shaft 226 and sleeve 406. In other embodiments, sleeve 406 and shaft 226 are slidably interfaced. Sleeve 406 extends upwards through upper member 124. Sleeve 406 can be rotatably interfaced (e.g., via a bearing) with a corresponding aperture of upper member 124. Sleeve 406 is centered about central axis 150 and is co-axial with shaft 126. Sleeve 406 is configured to rotate about central axis 150 relative to shaft 126. Sleeve 406 is also configured to rotate relative to any of upper member 124, sidewall, 122, sidewall 132, sidewall 154, etc., or any other stationary or housing component/member of printhead 100.

Sleeve 406 includes one or more protrusions, elongated members, cantilever members, beams, bars, paddles, L-shaped members, etc., shown as elongated members 302. Elongated members 302 protrude/extend radially outwards from sleeve 406. Elongated member 302 are configured to pass through mixture 186 present within inner volume 152. Elongated member 302 can facilitate mixing of mixture 186 within inner volume 152. Elongated members 302 can be rigid members, or flexible members.

Elongated members 302 each include one or more mixing members, planar members, spherical members, ellipsoid members, cubical members, paddles, agitators, agitator paddles, etc., shown as members 300. Members 300 are configured to pass through mixture 186 as sleeve 406 rotates. Members 300 may have any size, shape, depth, height, etc., such that they provide some amount of surface area that passes through mixture 186. Members 300 can facilitate mixing, processing, etc., of mixture 186. Members 300 also provide a known surface area that passes through mixture 186. As sleeve 406 rotates and members 300/elongated members 302 pass through mixture 186, members 300/elongated members 302 experience drag forces (e.g., forces/pressure due to fluid resistance). These drag forces exert a torque on sleeve 406 in a direction that opposes the direction of rotation of sleeve 406 (e.g., a direction opposite direction 200). The torque exerted, τₛₗₑₑᵥₑ, can be related to the viscosity μₘₐₜₑᵣᵢₐₗ of mixture 186. The torque may also be related to (e.g., proportional to) the radial distance between central axis 150 and members 300 (e.g., the length of elongated members 302 in a radial direction relative to central axis 150), and a surface area of members 300 that is exposed to mixture 186. The torque can also be related to the shape of members 300. Members 300 can be paddles, or mixing members. Members 300 can be both a mixing member, as well as a rheometer sensing member (e.g., facilitates measuring one or more rheological properties of the material/mixture).

Sleeve 406 is driven by a primary mover, engine, motor, etc., shown as motor 400. Motor 400 can be configured to drive (e.g., rotate) sleeve 406 via a drivetrain (e.g., a belt, a gear train, chains, sprockets, etc.), shown as flexible drive member 404. Flexible drive member 404 can be a pulley, a chain, or any other tensile member that can transfer angular kinetic energy from a driveshaft 402 of motor 400 to sleeve 406. Flexible drive member 404 can interface with sleeve 406 via a frictional or a toothed interface. In other embodiments, a gear reduction is disposed between driveshaft 402 of motor 400 and sleeve 406. Motor 400 can be a constant-speed output motor that rotates sleeve 406 at a constant angular velocity ωₛₗₑₑᵥₑ. In other embodiments, motor 400 is a constant torque motor (e.g., a motor that outputs a constant torque at driveshaft 402).

Sleeve 406, elongated members 302, and members 300 define a rheometer device that can be used to determine the dynamic viscosity of the mixture within hopper 104.

A torque sensor, shown as motor sensor 386 is configured to measure torque output by motor 400 at either driveshaft 402 or at sleeve 406. Motor sensor 386 can be a torque transducer, or any other sensor configured to convert mechanical torque into an electrical output signal. Motor sensor 386 can be a single torque sensor, or a collection of torque sensors. In other embodiments, an accelerometer is position on any of elongated members 302 and/or any of members 300. The accelerometer can be configured to monitor flexion of elongated members 302. Motor sensor 386 can include an RPM sensor (e.g., a tachometer) that is configured to measure angular speed (e.g., co or RPM) of driveshaft 402 or sleeve 406.

The RPM sensor is positioned at driveshaft 402 or at sleeve 406. The RPM measured by the tachometer/RPM sensor can be related to the torque (i.e., counter-torque) exerted on sleeve 406 by mixture 186. In other embodiments, a strain gauge is applied to sleeve 406 that can be configured to measure the torque τₛₗₑₑᵥₑ. In some embodiments, both a tachometer/RPM sensor and torque sensor are used to measure the speed (e.g., ωₛₗₑₑᵥₑ) and the torque (e.g., τₛₗₑₑᵥₑ) of sleeve 406 or driveshaft 402. Similar motor sensor(s) 386 can be configured to measure a current angular speed and torque of shaft 126.

Sleeve 406 can be configured to rotate independently of shaft 126. Sleeve 406 can rotate in a same direction as shaft 126 or can rotate in an opposite direction of shaft 126. Additionally, the direction of sleeve 406 and/or shaft 126 can be reversed. For example, shaft 126 can be rotated in either direction to either push material out of printhead 100 via outlet aperture 108 or to push material upwards from outlet portion 106 into inner volume 152. Likewise, sleeve 406 can be rotated in either direction (independently of shaft 126) throughout operation of printhead 100.

The fill level (i.e., Fill %) or the distance d (i.e., distance 352) between optical transducer 350 and surface 184 of mixture 186 can be used to determine distance 353 (i.e., h). Distance 353, h, is the head pressure between surface 814 of mixture 186 and outlet aperture 108. If the longitudinal distance dₜₒₜ (i.e., dₜₒₜ=h+d) between optical transducer 350 and outlet aperture 108 is known, distance 353 can be determined as h=dₜₒₜ−d.

Referring to FIGS. 3-4, printhead 100 can include a window, aperture, opening, bore, hole, receiving portion, void, open space, port, gap, mouth, etc., shown as material opening 192. Material opening 192 is fluidly coupled with inner volume 152 of hopper 104. Material opening 192 facilitates the entry of material, additives, etc., therethrough to inner volume 152. The material can be added in a dry or particulate form. In other embodiments, the material is added via material opening 192 in a semi-liquid or slurry state. Material opening 192 can be fluidly coupled with a material delivery system that provides dry/particulate components of mixture 186 to inner volume 152. The dry/particulate components of mixture 186 can be provided to inner volume 152 via a conveyor, a pump, an aerator, etc. The dry/particulate components of mixture 186 can be provided in an aerated form.

Referring now to FIG. 7, a control system 1000 includes controller 700, according to an exemplary embodiment. Controller 700 is configured to receive measurements of the weight wₜₒₜₐₗ of printhead 100 (including the weight wₘₐₜₑᵣᵢₐₗ of material within printhead 100) from weight sensor 360. Printhead 100 can be suspended from weight sensor 360 such that weight sensor 360 measures wₜₒₜₐₗ. Controller 700 is configured to receive measurements of distance 352 (i.e., d) between optical transducer 350 and the top surface of material within hopper 104 (e.g., surface 184) from optical transducer 350. Controller 700 is configured to receive measurements of torque τₛₗₑₑᵥₑ and/or angular speed ωₛₗₑₑᵥₑ (e.g., in RPM) of sleeve 406 or driveshaft 402 from motor sensors 386 associated with motor 400 (or with sleeve 406). Controller 700 can also receive measurements of torque τ_{shaft} and/or angular speed ω_{shaft} (e.g., in RPM) of shaft 126 or driveshaft 182 of drive motor 180. Controller 700 can also receive user inputs from a user interface 710.

User interface 710 can be a human machine interface, a personal computer device, a display screen, etc. User interface 710 can include any number of buttons, levers, knobs, switches, etc. User interface 710 can be a touchscreen device configured to receive a user input and provide a signal associated with the user input to controller 700.

Controller 700 is configured to determine control signals for any of the various devices/controllable elements of printhead 100, and material delivery system 2000. Material delivery system 2000 is configured to provide any required ingredients (e.g., materials, admixtures, additives, fluids, etc.) to hopper 104 of printhead 100. Material delivery system 2000 can include a pump, shown as water pump 390. Water pump 390 is configured to delivery water or any other fluid to hopper 104 (e.g., to inner volume 152 of hopper 104). Water pump 390 can be configured to provide water or fluid to water delivery actuator 380. Water pump 390 can be fluidly coupled with any plumbing components, pipes, conduits, hoses, tubular members, etc., that are fluidly coupled with inner volume 152 of hopper 104 (e.g., fluidly coupled with inlet 112). Water pump 390 can be configured to supply hopper 104 with water or fluid from a reservoir (e.g., a tank).

Material delivery system also includes a compressor, a motor, a blower, a pump, a conveyor, etc., shown as material delivery mover 392. Material delivery mover 392 can be any device or collection of devices configured to provide particulate material to hopper 104 (e.g., to inner volume 152 of hopper 104 through material opening 192). The particulate material can be cement, plasticizer, etc., or any other additive of ingredient of a desired mixture/material.

Controller 700 is configured to provide control signal to drive motor 180 and motor 400 to operate drive motor 180 and motor 400. Controller 700 can also be configured to provide control signals to water delivery actuator 380 to operate water delivery actuator 380. The control signals provided to drive motor 180 and motor 400 can include an angular speed at which to operate each of drive motor 180 and motor 400. For example, controller 700 can provide drive motor 180 with a control signal to operate (or change (e.g., increase or decrease)) the angular speed ω_{drivemotor} of drive motor 180 to achieve a desired angular speed ω_{shaft} of shaft 126. If shaft 126 is directly coupled to drive motor 180 without any gear reductions, ω_{drivemotor}=ωₛₗₑₑᵥₑ.

Controller 700 provides motor 400 with control signals to operate (or change (e.g., increase, decrease)) the angular speed ωₘₒₜₒᵣ of motor 400 to achieve a desired angular speed ωₛₗₑₑᵥₑ of sleeve 406.

Controller 700 provides water pump 390 with control signals to operate water pump 390 at an angular speed ωₚᵤₘₚ or to provide the water or fluid to hopper 104 (or valve 382) at a desired volumetric flow rate. The control signals provided to material delivery system 2000 can also operate material delivery system 2000 to provide a metered amount of water or liquid to hopper 104. Likewise, controller 700 provides material delivery mover 392 with control signals to operate material delivery mover 392 to provide a metered amount of dry ingredients (e.g., cement) to hopper 104. In some embodiments, the control signals provided to material delivery mover 392 cause material delivery mover 392 to operate according to an angular speed ωₘₒᵥₑᵣ (e.g., if material delivery mover 392 is a pump). In some embodiments, material delivery system 2000 is configured to delivery water to hopper 104 via water pump 390 and dry ingredients are added manually by a skilled technician.

Controller 700 operates material delivery system 2000 to introduce some amount of liquid or water (e.g., a certain volume of water or fluid/liquid, a certain mass of water of fluid/liquid, a certain weight of water or fluid/liquid, etc.) to hopper 104. Controller 700 is also configured to operate material delivery system 2000 to provide some amount of dry ingredients (e.g., mass, volume, weight, etc.) to hopper 104. In some embodiments, controller 700 is configured to provide a trained technician with an indication of a quantity of (e.g., weight, mass, volume, etc.) water or fluid and/or a quantity of (e.g., weight, mass, volume, etc.) dry ingredients that should be provided to inner volume 152 of hopper 104. Controller 700 can determine when various quantities of ingredients (e.g., wet ingredients such as water, dry ingredients such as cement, etc.) should be introduced to hopper 104. Controller 700 can either operate material delivery system 2000 to automatically add the ingredients to hopper 104 and operate printhead 100 to mix the ingredients therewithin, or can provide a skilled technician with an indication to manually add some amount of each ingredient (via user interface 710). In some embodiments, controller 700 uses some combination of both operating material delivery system 2000 and providing the skilled technician/operator with the quantities of the various ingredients that material delivery system 2000 is operating to provide to both automatically add/mix ingredients in hopper 104 and to notify the operator/technician with an indication of the quantity of the ingredients that are being provided to/mixed in hopper 104. For example, if controller 700 determines that an additional quantity of water should be added to hopper 104, controller 700 may operate material delivery system 2000 (e.g., water pump 390) to add the additional quantity of water to hopper 104 and provide the skilled technician with an indication of the additional quantity of water being provided to hopper 104 via user interface 710.

Controller 700 can monitor the various sensory inputs (e.g., the weight measurements as received from weight senor 360, the distance value d received from optical transducer 350, the torque/RPM measurements received from motor sensor(s) 386, etc.), and determine one or more rheological properties of the material/mixture within hopper 104. Controller 700 can use any of the various sensory inputs to determine a quantity of wet ingredients and/or a quantity of dry ingredients that should be added to hopper 104. Controller 700 can provide any of the rheological properties to the operator/technician via user interface 710. Controller 700 can also provide the operator/technician with any of the sensory inputs via user interface 710. Controller 700 can also operator printhead 100 based on any of the determined rheological properties of the material/mixture within hopper 104 and/or based on any of the sensory inputs.

Controller 700 can also provide control signals to printhead movers 709. Printhead movers 709 may be any primary movers (e.g., motors, pulleys, piston cylinders, hydraulic systems, etc.) of additive manufacturing system 10 that operate to adjust a position or an orientation of printhead 100. Controller 700 can operate printhead movers 709 and printhead 100 simultaneously/concurrently to operate additive manufacturing system 10 to print the material in hopper 104 to form a structure. The control signals that controller 700 provides to printhead movers 709 can cause printhead movers 709 to translate in an X direction, a Y direction, a Z direction, a radial direction, an angular direction, etc. Controller 700 may operate drive motor 180 to cause printhead 100 to emit or dispense material while operating printhead movers 709 to translate or move or rotate printhead 100 to additively manufacture the structure. In some embodiments, printhead movers 709 can operate according to a pattern or a program of commands provided by controller 700. Controller 700 can operate printhead movers 709 to iteratively translate printhead 100 along a path, while operating printhead 100 to dispense material to print various layers of the material.

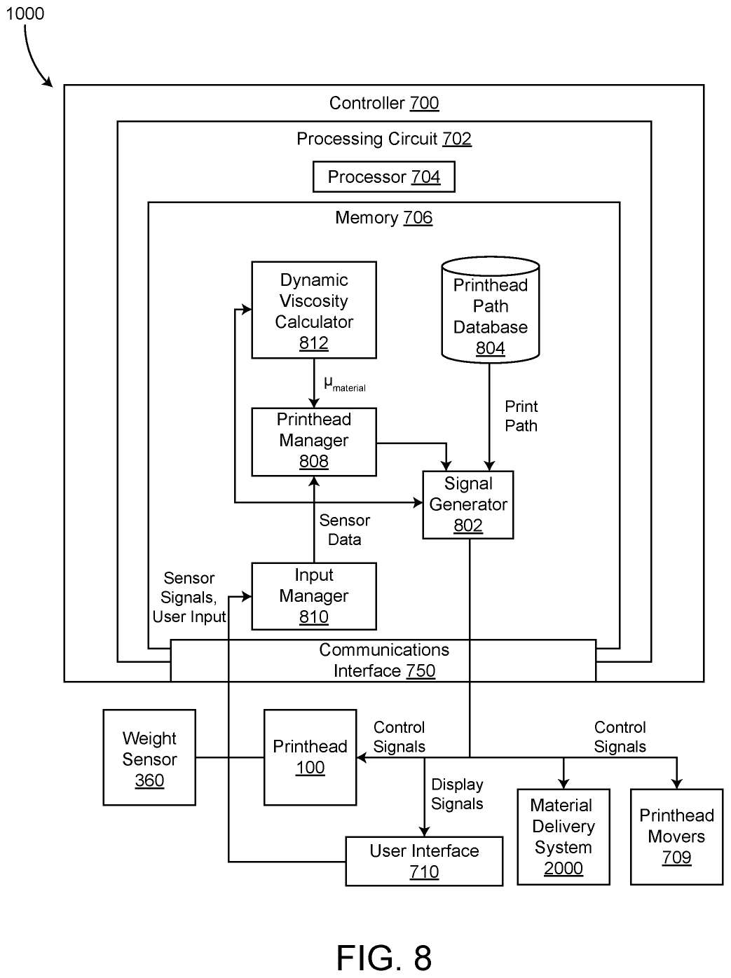

Referring now to FIG. 8, controller 700 can include a communications interface 750. Communications interface 750 may facilitate communications between controller 700 and external systems, devices, sensors, etc. (e.g., optical transducer 350, motor sensor(s) 386, drive motor 180, motor 400, water delivery actuator 380, water pump 390, material delivery mover 392, weight sensor 360, printhead movers 709, user interface 710, etc.) for allowing user control, monitoring, and adjustment to any of the communicably connected devices, sensors, systems, primary movers, etc. Communications interface 750 may also facilitate communications between controller 700 and user interface 710 (e.g., a touch screen, a display screen, a personal computer, etc.) or with a network.

Communications interface 750 can be or include wired or wireless communications interfaces (e.g., jacks, antennas, transmitters, receivers, transceivers, wire terminals, etc.) for conducting data communications with sensors, devices, systems, etc., of additive manufacturing system 10 or other external systems or devices (e.g., an administrative device). In various embodiments, communications via communications interface 750 can be direct (e.g., local wired or wireless communications) or via a communications network (e.g., a WAN, the Internet, a cellular network, etc.). For example, communications interface 750 can include an Ethernet card and port for sending and receiving data via an Ethernet-based communications link or network. In another example, the communications interface can include a Wi-Fi transceiver for communicating via a wireless communications network. In some embodiments, communications interface 750 is or includes a power line communications interface. In other embodiments, communications interface 750 is or includes an Ethernet interface, a USB interface, a serial communications interface, a parallel communications interface, etc.

Controller 700 includes a processing circuit 702, a processor 704, and memory 706. Processing circuit 702 can be communicably connected to the communications interface such that processing circuit 702 and the various components thereof can send and receive data via the communications interface. Processor 704 can be implemented as a general purpose processor, an application specific integrated circuit (ASIC), one or more field programmable gate arrays (FPGAs), a group of processing components, or other suitable electronic processing components.

Memory 706 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 706 can be or include volatile memory or non-volatile memory. Memory 706 can include database components, object code components, script components, or any other type of information structure for supporting the various activities and information structures described in the present application. According to some embodiments, memory 706 is communicably connected to processor 704 via processing circuit 702 and includes computer code for executing (e.g., by processing circuit 702 and/or processor 704) one or more processes described herein.

In some embodiments, controller 700 is implemented within a single computer (e.g., one server, one housing, etc.). In various other embodiments controller 700 can be distributed across multiple servers or computers (e.g., that can exist in distributed locations).

Memory 706 can include an input manager 810. Input manager 810 is configured to receive, retrieve, poll, etc., any of the sensory data from weight sensor 360, printhead 100, etc. Input manager 810 can be configured to receive signals from any of the sensors (e.g., optical transducer 350, motor sensor(s) 386, weight sensor 360) and convert the signals into meaningful information (e.g., angular speed in RPM, weight in lbf, distance in inches, etc.) that can be used by printhead manager 808. Input manager 810 is configured to collect, sort, aggregate, process, convert, etc., any of the sensor data and provide the sensor data to printhead manager 808.

Printhead manager 808 is configured to receive the sensor data/information from input manager 810 and determine various properties of the material based on the sensor data/information, as well as whether wet or dry ingredients should be added to achieve a particular property. Printhead manager 808 can use the sensor data directly to determine if wet or dry ingredients should be added, can use a calculation of the dynamic viscosity μₘₐₜₑᵣᵢₐₗ of the material as determined by dynamic viscosity calculator 812, or can use a combination of both.

Printhead manager 808 can receive the torque and/or angular velocity measured by motor sensors 386 of sleeve 406 and use the measured torque and/or angular velocity to determine if wet material should be added (or to determine if dry material should be added). Printhead manager 808 can store a target torque value τ_{target} and/or a target angular speed ω_{target} of sleeve 406. Deviations of the measured torque and/or angular velocity as measured by motor sensors 386 of sleeve 406 (or from a torque sensor positions on sleeve 406) can indicate that wet ingredients or liquid should be added or removed. If the measured torque (e.g., τₛᵢₑₑᵥₑ) exerted on sleeve 406 is greater than the target torque, printhead manager 808 can determine an amount of wet material (e.g., water) that should be added to hopper 104. This can advantageously prevent the mixture in hopper 104 from becoming too thick (or too viscous). Likewise, if the measured torque exerted on sleeve 406 is less than the target torque, printhead manager 808 can determine an amount of dry material (e.g., cement) that should be added to hopper 104. This can advantageously prevent the mixture in hopper 104 from becoming too thin or runny (or maintain a desired level of viscosity).

The amount of wet ingredients that should be added to hopper 104 to maintain the target torque (and thereby maintain a viscosity of the material in hopper 104) can be referred to as ΔQ_{wet}. ΔQ_{wet} may represent a mass, volume, weight, etc., of wet ingredients (e.g., water, liquid, etc.) that should be added to hopper 104 to return the measured/current torque to the target torque value. In some embodiments, ΔQ_{wet} is a function of the measured torque on sleeve 406 and the target torque, or a difference between the measured torque on sleeve 406 (e.g., ΔQ_{wet}=f(τₛₗₑₑᵥₑ, τ_{target}) or ΔQ_{wet}=f(Δτ) where Δτ=τₛₗₑₑᵥₑ−τ_{target}). The target torque τ_{target} can be a value that is stored in printhead manager 808 corresponding to a desired recipe of the mixture in hopper 104. In some embodiments, the desired recipe of the mixture in hopper 104 is input to controller 700 via user interface 710. Printhead manager 808 can retrieve an associated target torque value τ_{target} for the particular recipe of mixture that the user selects from a database (e.g., a table, a chart, etc.).

The amount of wet ingredients ΔQ_{wet} that should be provided to hopper 104 can be determined using any of a table, a graph, an equation, a model, etc. For example, printhead manager 808 may use a table that indicates an amount of wet ingredients ΔQ_{wet} that should be added to the mixture in hopper 104 based on the target torque value τ_{target} for the particular recipe, and based on the measured/current torque value τₛₗₑₑᵥₑ of sleeve 406. The table, graph, equation, etc., can be determined through experimental testing and may be stored in memory 706.

In some embodiments, printhead manager 808 uses a running average of the measured torque τₛₗₑₑᵥₑ to determine the amount of wet ingredients ΔQ_{wet} that should be added to the mixture in hopper 104. For example, printhead manager 808 may aggregate and/or average the measured torque τₛₗₑₑᵥₑ over a time period to determine an average value of the measured torque τ_{avg}. Printhead manager 808 can then use the average value of the measured torque to determine the amount of wet ingredients ΔQ_{wet} that should be added to the mixture in hopper 104 (e.g. based on a deviation of the average value of the measured torque from the target torque value).

Printhead manager 808 can similarly use the target angular speed ω_{target} of sleeve 406 to determine the amount of wet ingredients ΔQ_{wet} that should be added. For example, printhead manager 808 may determine a deviation of the measured angular speed ωₛₗₑₑᵥₑ from the target angular speed ω_{target} and determine an amount of wet ingredients that should be added based on the difference/deviation of the measured angular speed ωₛₗₑₑᵥₑ relative to the target angular speed ω_{target} of sleeve 406. In some embodiments, if the current/measured torque τₛₗₑₑᵥₑ or the average value of the measured torque τ_{avg} is greater than the target torque value τ_{target}, printhead manager 808 determines that wet ingredients should be added (e.g., ΔQ_{wet} amount). Printhead manager 808 can determine the amount of dry ingredients that should be added, ΔQ_{dry} similarly to the determination of the amount of wet ingredients that should be added ΔQ_{wet}. However, printhead manager 808 may use a different relationship (e.g., equation, table, function, etc.) specific to the particular recipe for the dry ingredients. In some embodiments, printhead manager 808 uses a relationship (e.g., table, function, etc.) to determine the amount of wet ingredients that should be added if the measured or average torque of sleeve 406 is greater than the target torque (e.g., Δτ is positive), and another relationship to determine the amount of dry ingredients that should be added if the measured or average torque of sleeve 406 is less than the target torque (e.g., Δτ is negative). In this way, wet ingredients can be added to “thin” the material in hopper 104, and dry ingredients can be added to “thicken” the material in hopper 104 (e.g., to increase or decrease the viscosity).

Printhead manager 808 can also include a minimum allowable torque value τₘᵢₙ, and a maximum allowable torque value τₘₐₓ. The minimum allowable torque value can be used by printhead manager 808 to determine if the material/mixture in hopper 104 is too thin. Likewise, the maximum allowable torque value can be used by printhead manager 808 to determine if the material/mixture in hopper 104 is too thick. If the current/measured torque value or the average torque value of sleeve 406 exceeds the maximum allowable torque value or goes below the minimum allowable torque value, printhead manager 808 may determine that the material/mixture within hopper 104 should be dumped or that a service technician should inspect hopper 104. In some embodiments, printhead manager 808 provides signal generator 802 with any of the amount of wet ingredients that should be added to hopper 104, the amount of dry ingredients that should be added to hopper 104, whether the current/measured (or average value) torque of sleeve 406 is greater than the maximum allowable torque value, whether the current/measured torque (or the average value of torque) of sleeve 406 is less than the minimum allowable torque value, etc. In some embodiments, the current/measured torque or the average value of the current/measured torque being greater than the maximum allowable torque value or less than the minimum allowable torque value indicates that the material/mixture is not suitable for additive manufacturing (e.g., the material is too thick for additive manufacturing, the material is too thin for additive manufacturing, etc.). In other embodiments, printhead manager 808 determines an amount of moisture reducing agent (e.g., water reducing agent) that should be provided to hopper 104 based on the deviation of the measured/sensed torque (or the average value of the torque) and the target torque to adjust the thickness (e.g., the viscosity) of the material.

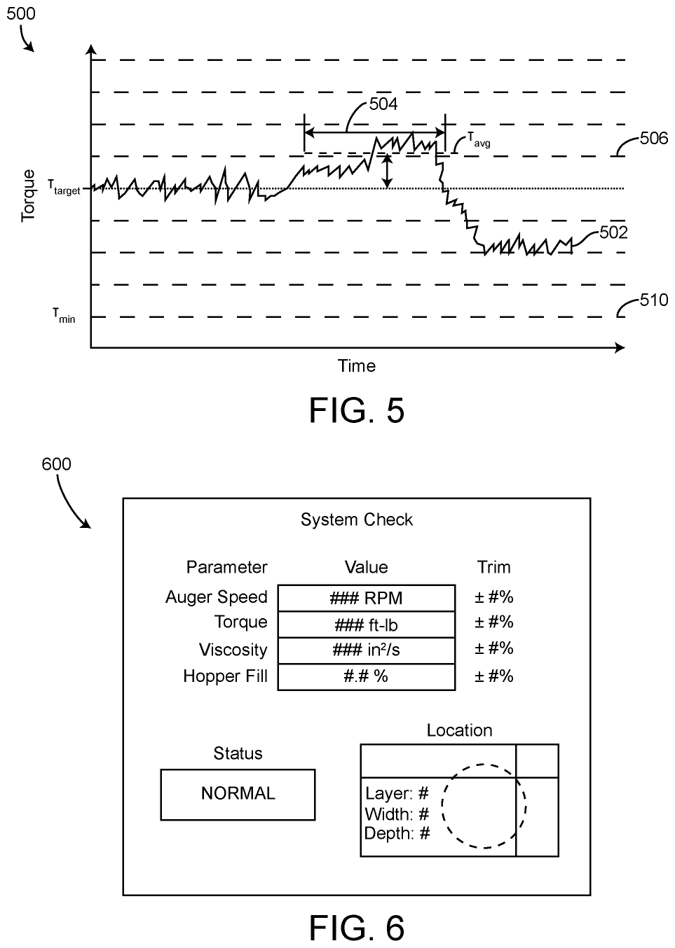

Referring now to FIG. 5, series 502 of graph 500 illustrates measured/sensed torque associated with sleeve 406 over time is shown, according to some embodiments. Graph 500 includes horizontal lines 506 that indicate various trigger values of the sensed/measured torque of sleeve 406. Horizontal line 510 represents the minimum allowable value of the measured torque τₘᵢₙ.If the measured torque of sleeve 406 decreases below horizontal line 510, controller 700 (specifically, printhead manager 808) can determine that the mixture is too watery (e.g., the dynamic viscosity of the mixture is too low) and can operate printhead movers 709 to move printhead 100 to a dump location, and operate printhead 100 to dump the unusable/unsuitable mixture/material.

Horizontal lines 506 above the target torque τ_{target} indicate various trigger values. Each trigger value is associated with an amount of wet ingredients that should be added to the mixture in hopper 104 to return the material to a desired thickness (e.g., a desired dynamic viscosity). Each horizontal line 506 above the target torque τ_{target} can be associated with a different amount of wet ingredients (e.g., water) that should be added to hopper 104. Controller 800 can average the measured/sensed values over a time period 504 of the torque to determine τ_{avg} (shown in FIG. 5). The average value of the measured torque can be a running average of the measured torque over time period 504 directly prior to a present moment in time.

If the average value of the measured torque exceeds a particular one of the horizontal lines 506 (e.g., exceeds a trigger value) above the target torque τ_{target}, controller 700 may retrieve a value of an amount of wet ingredients that should be added to hopper 104 associated with the particular one of the horizontal lines 506 and operates material delivery system 2000 to provide the amount of wet ingredients (e.g., water) to hopper 104.

Referring again to FIG. 8, printhead manager 808 can be configured to use the distance d as measured by the optical transducer 350 to determine how much material/mixture is present in hopper 104. Printhead manager 808 can determine an amount of material/mixture should be added to hopper 104 to return hopper 104 to a target fill level. For example, printhead manager 808 can use known geometry (e.g., radius, diameter, volume, size, etc.) of hopper 104 and the deviation of d from a target value d_{target} (e.g., a distance between optical transducer 350 and the top surface of the mixture within hopper 104 associated with a target fill level of hopper 104) to determine an amount of mixture that should be added to hopper 104 to return d to d_{target} (e.g., to return or maintain the target fill level of hopper 104). Printhead manager 808 can provide signal generator 802 with an amount of mixture that should be added to hopper 104 to maintain the desired/optimal fill level of hopper 104. The amount of mixture in hopper 104 produces head pressure above outlet aperture 108 which can affect the volumetric flow rate \dot{V}ₘₐₜₑᵣᵢₐₗ that exits printhead 100. For additive manufacturing, it is important to keep the volumetric flow rate of material substantially constant. Maintaining a constant fill level of hopper 104 facilitates keeping the volumetric flow rate of the material that exits printhead 100 constant, thereby improving the additive manufacturing.

Printhead manager 808 can also use the measured/sensed weight of hopper 104 as measured by weight sensor 360 to determine the fill level (or fill percentage) of mixture/material within hopper 104. Printhead manager 808 can store a known weight of printhead 100, and can determine the weight of the mixture/material within hopper 104 using wₘₐₜₑᵣᵢₐₗ=wₜₒₜₐₗ−w_{head} where wₘₐₜₑᵣᵢₐₗ is the weight of the mixture/material within hopper 104, wₜₒₜₐₗ is the total weight of printhead 100 (including the mixture/material, as measured by weight sensor 360), and w_{head} is the known weight of printhead 100 (without any material in hopper 104). Printhead manager 808 can use a relationship to determine the fill level of hopper 104 (e.g., using an average density as determined based on the dynamic viscosity calculated by dynamic viscosity calculator 812) based on the weight of mixture/material within hopper 104.

Printhead manager 808 can use any of the sensed information to determine an amount of wet ingredients that should be added, an amount of dry ingredients that should be added, whether the mixture/material in hopper 104 should be dumped, whether mixture should be added to hopper 104 to maintain a fill level, etc. Printhead manager 808 can output any of the determined operations to signal generator 802.

Controller 700 is also configured to determine dynamic viscosity of the mixture/material within hopper 104. Dynamic viscosity calculator 812 is configured to receive the torque measured by motor sensors 386 associated with sleeve 406 (or from a torque sensor on sleeve 406). The measured torque indicates resistive forces exerted on members 300 by the mixture as members 300 pass through the mixture. Dynamic viscosity calculator 812 can use a predetermined relationship (e.g., a function, a table, a graph, a model, etc.) to determine the dynamic viscosity of the mixture/material. For example, dynamic viscosity calculator 812 can use a function μₘₐₜₑᵣᵢₐₗ=f(τₛₗₑₑᵥₑ) or μₘₐₜₑᵣᵢₐₗ=f(τ_{avg}) to determine the dynamic viscosity μₘₐₜₑᵣᵢₐₗ of the material within hopper 104. In some embodiments, the function or the relationship is an empirical relationship, determined through testing various mixtures with different viscosities and measuring τₛₗₑₑᵥₑ and/or τ_{avg} associated with each of the different viscosities. In some embodiments, the function used by dynamic viscosity calculator 812 is specific to the recipe of the mixture in hopper 104. For example, different recipes may have different relationships between the torque exerted on sleeve 406 due to members 300 passing through the mixture/material present in hopper 104 and the dynamic viscosity μₘₐₜₑᵣᵢₐₗ of the mixture/material.

Dynamic viscosity calculator 812 may provide the determined/estimated dynamic viscosity μₘₐₜₑᵣᵢₐₗ of the material/mixture present within hopper 104 to printhead manager 808. Printhead manager 808 can use the estimated dynamic viscosity it μₘₐₜₑᵣᵢₐₗ of the material/mixture to determine the amount of wet ingredients ΔQ_{wet} that should be added to hopper 104, the amount of dry ingredients ΔQ_{dry} that should be added to hopper 104, the amount of moisture reducing agent that should be added to hopper 104, etc., to return or maintain a target dynamic viscosity μ_{target} of the material/mixture within hopper 104. Printhead manager 808 can use the estimated dynamic viscosity it μₘₐₜₑᵣᵢₐₗ similarly to the measured torque to determine quantities of wet ingredients, dry ingredients, moisture reducing ingredients, plasticizer, etc., to add to the mixture of hopper 104. Similarly, printhead manager 808 can determine if the material/mixture within hopper 104 has a dynamic viscosity less than a minimum allowable dynamic viscosity μₘᵢₙᵢₘᵤₘ or greater than a maximum allowable dynamic viscosity μₘₐₓᵢₘᵤₘ. Printhead manager 808 can provide signal generator 802 with an indication regarding whether the mixture within hopper 104 has a dynamic viscosity μₘₐₜₑᵣᵢₐₗ that is greater than the maximum allowable dynamic viscosity or less than the minimum allowable dynamic viscosity.

Signal generator 802 operates user interface 710 by providing display signals to user interface 710. Signal generator 802 can receive the determined amount of ingredients (e.g., dry, wet, plasticizer, moisture reducing agent, etc.) that should be provided to hopper 104 and operate printhead 100 and/or material delivery system 2000 to provide the determined amount of ingredients to hopper 104 (e.g., by generating control signals and providing the generated control signals to printhead 100 and material delivery system 2000). Signal generator 802 can generate control signals to operate water pump 390, material delivery mover 392, and/or water delivery actuator 380 to provide the determined amount of ingredients (e.g., ΔQ_{wet}, ΔQ_{dry}, an amount of moisture reducing agent, etc.) to hopper 104. Material delivery system 2000 (e.g., water pump 390 and/or material delivery mover 392) receive the control signals and provide the determined amount of ingredients to hopper 104. In some embodiments, controller 700 operates water delivery actuator 380 to meter the amount (e.g., as determined by printhead manager 808) of ingredients to hopper 104 so that the correct amount of ingredients are provided to inner volume 152. Signal generator 802 can also determine a percent change in the dynamic viscosity of

Signal generator 802 can also receive sensor data from input manager 810 or any of the sensors of printhead 100. Signal generator 802 is configured to generate display signals for user interface 710. The display signals cause user interface 710 to display any of the sensor information received from printhead 100 (or from weight sensor 360). For example, signal generator 802 can operate user interface 710 to display angular speed of shaft 126 (e.g., the auger), currently measured torque τₛₗₑₑᵥₑ, etc. Signal generator 802 can also receive the estimated dynamic viscosity μₘₐₜₑᵣᵢₐₗ from dynamic viscosity calculator 812 (or from printhead manager 808) and operate user interface 710 to display the estimated dynamic viscosity μ_{viscosity}. Signal generator 802 can also receive the fill level (e.g., fill percentage) from printhead manager 808 and operate user interface 710 to display the fill level of hopper 104. Signal generator 802 can also operate user interface 710 to display any of the additions of various ingredients. Signal generator 802 can also operate user interface 710 to display changes in the estimated dynamic viscosity, changes in the torque exerted on sleeve 406 (e.g., due to mixture/material resistance), changes in the angular speed of shaft 126, etc. Signal generator 802 is also configured to operate user interface 710 to display deviations of the torque τₛₕₑₐₜₕ (or τ_{avg}), deviations of μₘₐₜₑᵣᵢₐₗ, etc., from their respective target values. In some embodiments, signal generator 802 operates user interface 710 to display any of the various target values (e.g., τ_{target}, μ_{target}, etc.).

Signal generator 802 can also operate user interface 710 to display an operational status of printhead 100. For example, signal generator 802 may operate user interface 710 to display various messages such as “NORMAL,” “WARNING” and “STOPPED.” The “STOPPED” message can be provided if τₛₗₑₑᵥₑ exceeds or goes below the maximum or minimum threshold values, respectively. In some embodiments, the “STOPPED” message is provided if μₘₐₜₑᵣᵢₐₗ exceeds or goes below the maximum allowable or minimum allowable dynamic viscosity values, respectively. In some embodiments, the “WARNING” message is provided if μₘₐₜₑᵣᵢₐₗ is close (e.g., within a predetermined range) to μₘᵢₙᵢₘᵤₘ or μₘₐₓᵢₘᵤₘ. Likewise, the “WARNING” message can be provided if τₘₐₜₑᵣᵢₐₗ or τ_{avg} is close (e.g., within a predetermined range) to τₘᵢₙ or τₘₐₓ. The “NORMAL” message can be provided if τ_{avg} or τₛₗₑₑᵥₑ is within normal operating conditions (e.g., within τₘᵢₙ and τₘₐₓ) or if μ_{avg} or μₘₐₜₑᵣᵢₐₗ is within normal operating conditions (e.g., within μₘᵢₙᵢₘᵤₘ and μₘₐₓᵢₘᵤₘ).

Signal generator 802 is also configured to operate drive motor 180 to rotate shaft 126 and helical surfaces 128 to print mixture/material. Signal generator 802 can operate printhead movers 709 to translate or elevate printhead 100 along a print path. Signal generator 802 may receive the print path from a printhead path database 804. In some embodiments, signal generator 802 causes printhead movers 709 to iteratively sweep printhead 100 along the print path, with increasing elevations. This provides additive layers of material to produce a structure.

Signal generator 802 can operate drive motor 180 to cause shaft 126 and helical surfaces 128 to print the mixture/material of hopper 104 as printhead sweeps along the print path. In some embodiments, signal generator 802 stops drive motor 180 from rotating shaft 126 and/or stops printhead movers 709 from sweeping printhead 100 along the print path in response to printhead manager 808 determining that the estimated dynamic viscosity μₘₐₜₑᵣᵢₐₗ of the material/mixture in hopper 104 exceeds μₘₐₓᵢₘᵤₘ or is less than μₘᵢₙᵢₘᵤₘ (or if the torque τₛₗₑₑᵥₑ or τ_{avg} exceeds τₘₐₓ or goes below τₘᵢₙ). Signal generator 802 can then either operate user interface 710 to notify the operator that printhead 100 needs to be inspected, or can operate printhead movers 709 to translate printhead 100 to a dump location. Once printhead 100 is moved to the dump location, signal generator 802 can operate drive motor 180 to completely expel the mixture/material within hopper 104 and can notify the operator regarding the empty hopper 104.

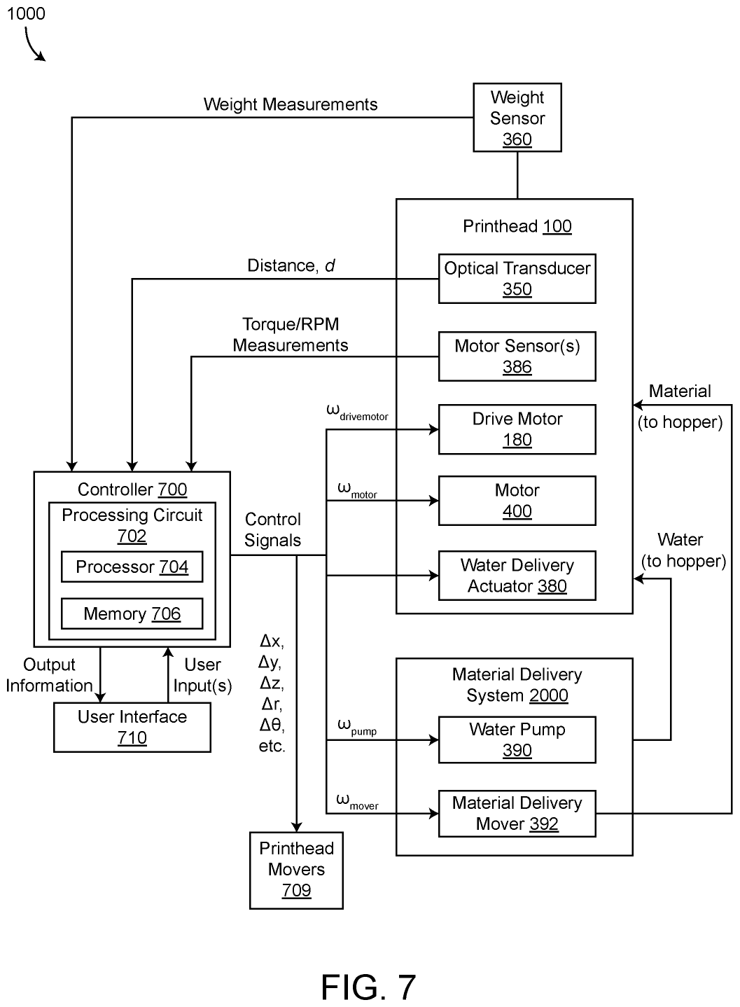

Referring now to FIG. 6, user interface 710 can be configured to provide display 600 to a user. Display 600 can include information regarding various parameters of printhead 100 including, but not limited to, auger speed (e.g., ω_{shaft}), torque (e.g., τ_{avg}, τₛₗₑₑᵥₑ, etc.), viscosity (e.g., μ_{avg}, μₘₐₜₑᵣᵢₐₗ, etc.), and hopper fill level (e.g., d, fill percentage of hopper 104, etc.). Display 600 can also include a notification regarding an operational status of printhead 100 (e.g., filling, printing, normal, warning, stopping, etc.). Display 600 can also include an image indicating what layer of additive printing is being performed (e.g., by additive manufacturing system 10), width of a structure being printed, and current depth of the structure being printed. Display 600 can, more generally, provide a graphical representation to the operator regarding the print path of printhead 100 and a current location of printhead 100 along the print path. Display 600 can also include trim amounts (e.g., in percentages) of any of the changes being performed to the various parameters of printhead 100.

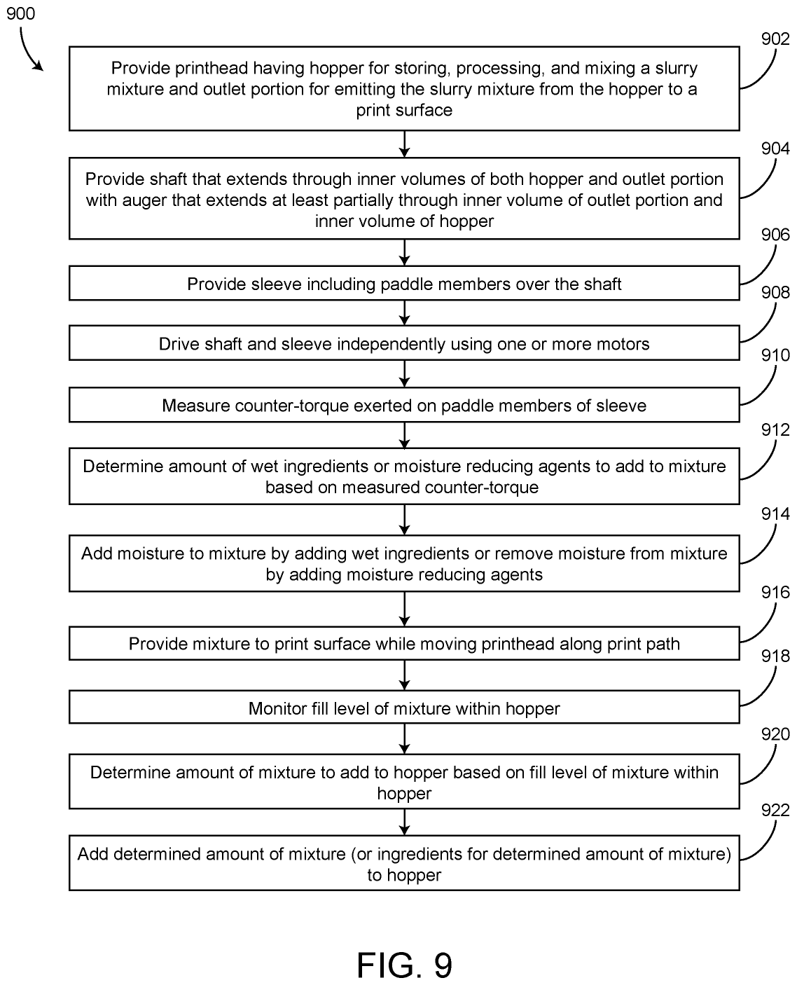

Referring now to FIG. 9, a process 900 for operating an additive manufacturing system using a printhead (e.g., printhead 100) to perform additive manufacturing with a slurry material (e.g., concrete, cement, etc.) is shown. Process 900 includes steps 902-922 and can be performed by various components of additive manufacturing system 10.

Process 900 includes providing a printhead (e.g., printhead 100) having a hopper (e.g., hopper 104) for storing, processing, and mixing a slurry mixture and an outlet portion (e.g., outlet portion 106) for emitting the slurry mixture from the hopper to a print surface (step 902). Step 902 can be performed by an operator of additive manufacturing system 10 or printhead 100 at a jobsite.

Process 900 includes providing a shaft that extends through inner volumes (e.g., inner volume 152, inner volume 156) of both the hopper and the outlet portion with an auger (e.g., helical surfaces 128) that extends at least partially through the inner volume of the outlet portion and the inner volume of the hopper (step 904). Step 904 can be performed by an operator of additive manufacturing system 10 or printhead 100 at a jobsite or while replacing helical surfaces 128 with other helical surfaces 128 (e.g., by releasing and removing sheath 191 from shaft 126).

Process 900 includes providing a sleeve (e.g., sleeve 406) including paddle members (e.g., elongated members 302 and members 300) (step 906). Elongated members 302 and members 300 may be protrusions with some surface area that is configured to pass through material/mixture present in hopper 104 as sleeve 406 rotates.

Process 900 includes driving the shaft and the sleeve independently using one or more motors (e.g., drive motor 180 and motor 400) (step 908). Step 908 can be performed by controller 700. Controller 700 can generate and provide control signals to drive motor 180 and motor 400 to rotate shaft 126 and sleeve 406 independently. Shaft 126 and sleeve 406 can be rotatably and slidably interfaced with each other to facilitate performing step 908.

Process 900 includes monitoring/measuring a counter torque (e.g., τₘₐₜₑᵣᵢₐₗ) exerted on the paddle members of the sleeve (step 910). Step 910 can be performed by measuring the torque applied to sleeve 406 due to fluidic resistance of the mixture/material in hopper 104. Step 910 can be performed by a torque sensor. The measured counter torque can be provided to controller 700 in step 910.

Process 900 includes determining an amount (e.g., ΔQ_{wet}) of wet ingredients (e.g., water) or an amount of moisture reducing agent (e.g., dry ingredients) to add to the mixture in the hopper based on the measured counter torque (step 912). Step 912 can be performed by controller 700 based on τₛₗₑₑᵥₑ or τ_{avg}. Step 912 can be performed by printhead manager 808 and/or dynamic viscosity calculator 812. Step 912 can include estimating the dynamic viscosity μₘₐₜₑᵣᵢₐₗ of the mixture/material within hopper 104 and using the estimated dynamic viscosity to determine the amount of wet ingredients or moisture reducing agent that should be added to the mixture in hopper 104.

Process 900 includes adding moisture to the mixture in the hopper by adding the determined amount of wet ingredients or removing moisture from the mixture by adding the determined amount of moisture reducing agents (step 914). Step 914 can be performed by controller 700 and material delivery system 2000. Step 914 can be facilitated by fluid connections between inner volume 152 of hopper 104 and material delivery system 2000.

Process 900 includes providing the mixture from the hopper to the print surface while moving the printhead along a print path (step 916). Step 916 can be performed by driving drive motor 180 such that shaft 126 and helical surfaces 128 rotate to provide the mixture in hopper 104 through outlet aperture 108 to the print surface. Step 916 can be performed consecutively for each layer of material that should be added to the print surface. For consecutive iterations of step 916, the print surface can be an upper surface of a previously provided layer of mixture/material from hopper 104.

Process 900 includes monitoring a fill level (e.g., distance 352 or distance 353) of the mixture in the hopper (step 918). Step 918 can be performed by controller 700 and optical transducer 350. Optical transducer 350 can measure distance 352 and provide the value of distance 352 to controller 700. Controller 700 can use distance 352 and known geometry of printhead 100 (e.g., known geometry of hopper 104) to determine the fill level of mixture within hopper 104. In some embodiments, step 918 includes receiving a weight measurement from weight sensor 360 and determining or validating the fill level based on the received weight measurement.

Process 900 includes determining an amount of mixture to add to the hopper based on the fill level of the mixture within the hopper (step 920) and adding the determined amount of mixture (or ingredients for the determined amount of mixture) to the hopper (step 922). Steps 918-922 can be performed concurrently with step 916 to maintain a target fill level of mixture within hopper 104 and thereby maintain a constant head pressure of mixture/material provided to outlet portion 106 (or outlet aperture 108). Step 920 can be performed by controller 700 based on the fill level (as determined in step 918) of mixture within hopper 104 and the target fill level value. Step 922 can be performed by material delivery system 2000 (in response to receiving control signals from controller 700 to provide additional ingredients for the mixture in hopper 104).

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claim.

1. A printhead for an additive manufacturing system, the printhead comprising:
a hopper comprising an inner volume configured to store a slurry material for mixing;
an outlet comprising a passageway fluidly coupled with the hopper, the outlet comprising an open end for discharging the slurry material to a surface through the passageway;
a mixing shaft extending through the inner volume of the hopper and comprising a member that extends radially outwards from the mixing shaft, the member configured to mix the slurry material within the hopper as the mixing shaft rotates;
a drive shaft extending through the inner volume of the hopper and at least partially into the passageway of the outlet, the drive shaft comprising a sloped surface configured to drive the slurry material from the hopper to the surface through the passageway of the outlet.

2. The printhead of claim 1, further comprising:
a first motor configured to drive the drive shaft to discharge the slurry material from the hopper, through the passageway of the outlet to the surface; and
a second motor configured to drive the mixing shaft to mix the slurry material within the hopper;
wherein the mixing shaft and the drive shaft are driven independently of each other to mix the slurry material and discharge the slurry material.

3. The printhead of claim 1, wherein the mixing shaft and the drive shaft are coaxial with each other and the mixing shaft is a hollow member comprising a central inner volume and having an overall length that is less than an overall length of the drive shaft and the drive shaft extends through the central inner volume of the mixing shaft.

4. The printhead of claim 1, wherein the drive shaft comprises an auger that extends through at least a portion of the passageway of the outlet and the sloped surface is a helical surface.

5. The printhead of claim 1, further comprising a torque sensor configured to measure torque exerted on the mixing shaft as the mixing shaft rotates to mix the slurry material.

6. The printhead of claim 1, further comprising an emitter configured to emit a wave towards a top surface of the slurry material to determine a level of the slurry material within the printhead.

7. The printhead of claim 1, further comprising an additive inlet, the additive inlet fluidly coupled with an additive source through a tubular member, wherein the additive inlet, the tubular member, and the additive source are configured to provide an additive to the inner volume of the hopper to adjust a moisture of the slurry material.

8. A system for additive manufacturing with a slurry material, the system comprising:
an adjustable support structure;
a printhead suspended from the adjustable support structure, the printhead comprising:
a hopper configured to store a slurry material and an outlet fluidly coupled with the hopper and configured to discharge the slurry material;
a first shaft configured to be driven by a first motor to mix the slurry material;
a second shaft configured to be driven by a second motor to discharge the slurry material; and
a controller configured to:
operate a primary mover of the adjustable support structure to reposition the printhead; and
operate the first motor and the second motor of the printhead to mix the slurry material and discharge the slurry material.

9. The system of claim 8, wherein:
the printhead further comprises a torque sensor configured to measure torque exerted on the first shaft as the first shaft is driven to mix the slurry material; and
the controller is configured to:
obtain the torque exerted on the first shaft from the torque sensor; and
determine a current value of dynamic viscosity of the slurry material using the torque exerted on the first shaft.

10. The system of claim 9, wherein the printhead comprises:
an additive inlet, the additive inlet configured to receive an additive from an additive system and provide the additive to the slurry material;
wherein the controller is configured to operate the additive system to provide the additive to the slurry material based on the current value of dynamic viscosity of the slurry material to achieve a desired value of the dynamic viscosity of the slurry material.

11. The system of claim 10, wherein the additive is a moisture increasing agent or a moisture absorbing agent;
wherein the moisture increasing agent increases a moisture of the slurry material and decreases the current value of the dynamic viscosity of the slurry material when mixed with the slurry material; and
wherein the moisture absorbing agent decreases the moisture of the slurry material and increases the current value of the dynamic viscosity of the slurry material when mixed with the slurry material.

12. The system of claim 8, wherein the printhead further comprises an optical transducer configured to emit a wave in a direction towards a top surface of the slurry material to determine a distance between the optical transducer and the top surface of the slurry material and the controller is configured to:
determine a fill level of the slurry material within the printhead based on the distance between the optical transducer and the top surface of the slurry material;
operate a user interface to provide a notification to add additional material in response to the fill level of the slurry material being less than or equal to a threshold amount.

13. The system of claim 8, wherein the controller is configured to operate the primary mover of the adjustable support structure to move the printhead along a printhead path while concurrently operating the second motor to drive the second shaft to discharge the slurry material to produce a structure.

14. The system of claim 8, wherein the slurry material is a concrete or cement material.

15. A method for performing additive manufacturing with a slurry material, the method comprising:
providing a printhead having a hopper for storing, processing, and mixing a slurry material and an outlet portion for discharging the slurry material to a print surface, the printhead comprising a first shaft configured to be driven by a first primary mover to mix the slurry material and a second shaft configured to be driven by a second primary mover to discharge the slurry material through the outlet portion;
driving the first shaft and the second shaft to independently mix and discharge the slurry material to the print surface;
monitoring an amount of counter-torque exerted on the first shaft to determine a dynamic viscosity of the slurry material; and
adding a wet ingredient or a moisture absorbing agent to the slurry material based on the dynamic viscosity of the slurry material to achieve a desired value of the dynamic viscosity.

16. The method of claim 15, further comprising:
operating an adjustable structure from which the printhead is suspended to move the printhead along a print path while concurrently driving the second shaft to discharge the slurry material to the print surface along the print path.

17. The method of claim 16, wherein the adjustable structure is configured to adjust a position of the printhead in at least three spatial directions.

18. The method of claim 15, further comprising:
operating an optical transducer to emit a wave towards a top surface of the slurry material that is within the hopper to determine a distance between the optical transducer and the top surface of the slurry material; and
determining a fill level of the slurry material within the hopper based on the distance between the optical transducer and the top surface of the slurry material.

19. The method of claim 18, further comprising:
comparing the fill level to a threshold to determine an amount of additional material should be added to the hopper; and
operating a user interface to indicate the amount of additional material that should be added to the hopper.

20. The method of claim 16, further comprising operating a user interface to display at least one of:
the amount of counter-torque exerted on the first shaft;
a speed of at least one of the first shaft or the second shaft;
a status of the printhead;
a fill level of the slurry material within the hopper of the printhead;
the dynamic viscosity of the slurry material;
a position of the printhead along a print path;
a total depth of the slurry material discharged onto the print surface; or
a total number of layers of the slurry material that have been discharged onto the print surface.
